(19) United States
(12) Patent Application Publication
(10) Pub. No.: US 2025/0256503 A1
(43) Pub. Date: Aug. 14, 2025

(54) CONTACT-TYPE PATTERNING APPARATUS

(71) Applicants: Samsung Display Co., Ltd., Yongin-si (KR); Enjet Co. Ltd, Suwon-si, Gyeonggi-do (KR)

(72) Inventors: SEUNGMIN HONG, Yongin-si (KR); SUKJU KANG, Yongin-si (KR); Doyoung BYUN, Suwon-si (KR); Baekhoon SEONG, Suwon-si (KR); Raehyun KIM, Suwon-si (KR); BYUNGSU KIM, Yongin-si (KR); JAEGI YOO, Yongin-si (KR); Jaesung CHA, Suwon-si (KR)

(21) Appl. No.: 18/909,564

(22) Filed: Oct. 8, 2024

(30) Foreign Application Priority Data
Feb. 8, 2024 (KR) 10-2024-0019772

(51) Int. Cl. B41J 2/035; B41J 2/02; B41J 2/175; B41J 3/407; B41J 11/06; B41J 11/14; B41J 13/00; B41J 15/04

(52) U.S. Cl. CPC B41J 2/035; B41J 2/17596; B41J 3/4073; B41J 11/06; B41J 11/14; B41J 13/0027; B41J 15/04; B41J 2002/022

(57) ABSTRACT

A contact-type patterning apparatus includes: a nozzle comprising an electrode configured to receive a voltage to generate an electric field toward a substrate, and configured to eject a fluid so that the fluid is connected to the substrate; a voltage supply configured to apply the voltage to the electrode; a screw-type pump configured to supply the fluid into the nozzle through a screw configured to receive power from a motor to rotate; a transfer part configured to transfer the nozzle or the substrate so that the fluid is patterned in a line shape; and a controller configured to control a level of the voltage applied through the voltage supply, an operation of the transfer part, and an operation of the pump.

### CROSS-REFERENCE TO RELATED APPLICATION

The present application claims priority to and the benefit of Korean Patent Application No. 10-2024-0019772, filed on Feb. 8, 2024, in the Korean Intellectual Property Office, the entire disclosure of which is incorporated herein by reference.

### BACKGROUND

### 1. Field

Aspects of some embodiments of the present disclosure relate to a contact-type patterning apparatus.

### 2. Description of the Related Art

Processes of manufacturing LCDs, touch screen panels and the like involve various operations for forming fine patterns on substrates.

Etching techniques such as light exposure may be used as techniques for forming such fine patterns. However, in the etching techniques, spaces in which etching is performed need to be maintained in a vacuum state, and thus manufacturing time and manufacturing costs may increase.

Accordingly, inkjet printing techniques of spaying inks onto substrates to form patterns may be utilized. In inkjet printing techniques, as inks including electrode materials are sprayed onto objects to form patterns, the manufacturing costs may be relatively reduced. However, there may be a limitation that it may be difficult to utilize inks having a high viscosity to form patterns having a fine line width.

Meanwhile, contact-type printing apparatuses, in which inks dispensed from nozzles are in direct contact with objects to perform continuous line patterning in order to achieve the fine line width through the inkjet printing techniques may be utilized.

However, in a contact-type patterning method, as a patterning speed is increased, the inks may be disconnected without maintaining a contact state with objects to cause discontinuous sections. Accordingly, the continuous line patterning may be difficult to perform. For example, there may be a limitation that when the continuous patterning is formed, a line width or a thickness may not be constant in acceleration and deceleration sections around a start point and an end point of a pattern compared to an intermediate point.

The above information disclosed in this Background section is only for enhancement of understanding of the background and therefore the information discussed in this Background section does not necessarily constitute prior art.

### SUMMARY

Aspects of some embodiments of the present disclosure relate to a contact-type patterning apparatus, and for example, to a contact-type patterning apparatus that allows an ink ejected from a nozzle to be in direct contact with a substrate to perform continuous line patterning.

Aspects of some embodiments of the present disclosure may include a contact-type patterning apparatus which uses a screw-type pump, and synchronizes and controls a voltage applied to a nozzle, a patterning rate, and an operation of the pump to be capable of performing a patterning process in a constant line width even with an ink having a high viscosity in a contact manner without a discontinuous section.

The characteristics of embodiments according to the present disclosure are not limited to the aforesaid, but other characteristics not described herein will be more clearly understood by those skilled in the art from descriptions below.

Aspects of some embodiments according to the present disclosure include a contact-type patterning apparatus including a nozzle which includes an electrode that receives a voltage to generate an electric field toward a substrate, and ejects a fluid so that the fluid is connected to the substrate, a voltage supply part which applies the voltage to the electrode, a screw-type pump which supplies the fluid into the nozzle through a screw that receives power from a motor to rotate, a transfer part which transfers the nozzle or the substrate so that the fluid is patterned in a line shape, and a controller which controls a level of the voltage applied through the voltage supply part, an operation of the transfer part, and an operation of the pump.

According to some embodiments, the controller may synchronize and control a transfer speed of the substrate or the nozzle by the transfer part and a rotation speed of the motor of the pump, and control the level of the voltage applied to the electrode from the voltage supply part according to the synchronized speed control.

According to some embodiments, in an acceleration section of the transfer part, in which the patterning starts, and a deceleration section of the transfer part, in which the patterning ends, the controller may synchronize and control the transfer speed of the substrate or the nozzle by the transfer part and the rotation speed of the motor of the pump, and control the level of the voltage applied to the electrode from the voltage supply part according to the synchronized speed control.

According to some embodiments, the substrate may be transferred in a stage moving manner, and the controller may control a movement speed of a stage, which supports the substrate, to control the transfer speed of the substrate.

According to some embodiments, the substrate may be transferred in a roll-to-roll manner, and the controller may control a rotation speed of a roll, which supports the substrate, to control the transfer speed of the substrate.

According to some embodiments, the substrate may be transferred in a conveyor manner, and the controller may control a movement speed of a conveyor, on which the substrate is seated, to control the transfer speed of the substrate.

According to some embodiments, a connecting portion between the motor of the pump and the screw may include an insulation material so that when the voltage supplied from the voltage supply part is blocked from being applied to the motor.

According to some embodiments, the fluid may have a viscosity of about 200,000 cP or less.

According to some embodiments, the contact-type patterning apparatus may further include a shape information providing part that provides three-dimensional surface shape information of the substrate. In consideration of a change in distribution of the electric field according to the three-dimensional surface shape information provided from the shape information providing part, the controller may control the level of the voltage applied to the electrode through the voltage supply part.

According to some embodiments, the contact-type patterning apparatus may further include a flow rate monitoring part that monitors a flow rate of the fluid ejected from the nozzle, and the flow rate monitoring part may include a camera that photographs the fluid ejected from the nozzle.

According to some embodiments, the pump may be a uniaxial eccentric screw pump.

### BRIEF DESCRIPTION OF THE DRAWINGS

The accompanying drawings are included to provide a further understanding of embodiments according to the present disclosure, and are incorporated in and constitute a part of this specification. The drawings illustrate aspects of some embodiments of the present disclosure and, together with the description, serve to explain aspects of some embodiments of the present disclosure. In the drawings:

FIG. 1 is a schematic view illustrating a configuration of a contact-type patterning apparatus according to some embodiments of the present disclosure;

FIG. 2 is a view illustrating a contact-type patterning apparatus in a conveyor manner according to some embodiments of the present disclosure;

FIG. 3 is a view illustrating a contact-type patterning apparatus in a roll-to-roll manner according to some embodiments of the present disclosure;

FIG. 4 is a view for comparing ejected shapes of inks according to control of a controller;

FIG. 5 is a view illustrating one example of a synchronization profile of a stage driving motor and a motor of a pump according to a patterning section;

FIG. 6 is a view illustrating a result of synchronizing a stage driving motor and a motor of a pump to perform a patterning process;

FIG. 7 is a view illustrating a result of synchronizing a stage driving motor and a motor of a pump and also controlling a level of a voltage applied to an electrode from a controller to perform patterning;

FIG. 8 illustrates a contact-type patterning apparatus for a substrate S having a three-dimensional surface according to some embodiments of the present disclosure; and

FIGS. 9 and 10 are views for describing a patterning operation of a contact-type patterning apparatus according to some embodiments of the present disclosure.

### DETAILED DESCRIPTION

In this specification, it will be understood that when an element (or region, layer, section, etc.) is referred to as being “on”, “connected to” or “coupled to” another element, it can be located directly on, connected or coupled to the other element or a third element may be located between the elements.

Like reference numbers or symbols refer to like elements throughout. In addition, in the drawings, the thickness, the ratio, and the dimension of elements are exaggerated for effective description of the technical contents.

The term “and/or” includes one or more combinations which may be defined by relevant elements.

It will be understood that, although the terms first, second, etc. may be used herein to describe various elements, these elements should not be limited by these terms. These terms are only used to distinguish one element from another element.

For example, a first element could be termed a second element without departing from the teachings of the present invention, and similarly, a second element could be termed a first element. As used herein, the singular forms are intended to include the plural forms as well, unless the context clearly indicates otherwise.

In addition, the terms, such as “below”, “beneath”, “on” and “above”, are used for explaining the relation of elements shown in the drawings. The terms are relative concepts and are explained based on the direction shown in the drawing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms such as “includes” or “has”, when used herein, specify the presence of stated features, numerals, steps, operations, elements, parts, or the combination thereof, but do not preclude the presence or addition of one or more other features, numerals, steps, operations, elements, parts, or the combination thereof.

Hereinafter, aspects of some embodiments of the present disclosure will be described in more detail with reference to the accompanying drawings.

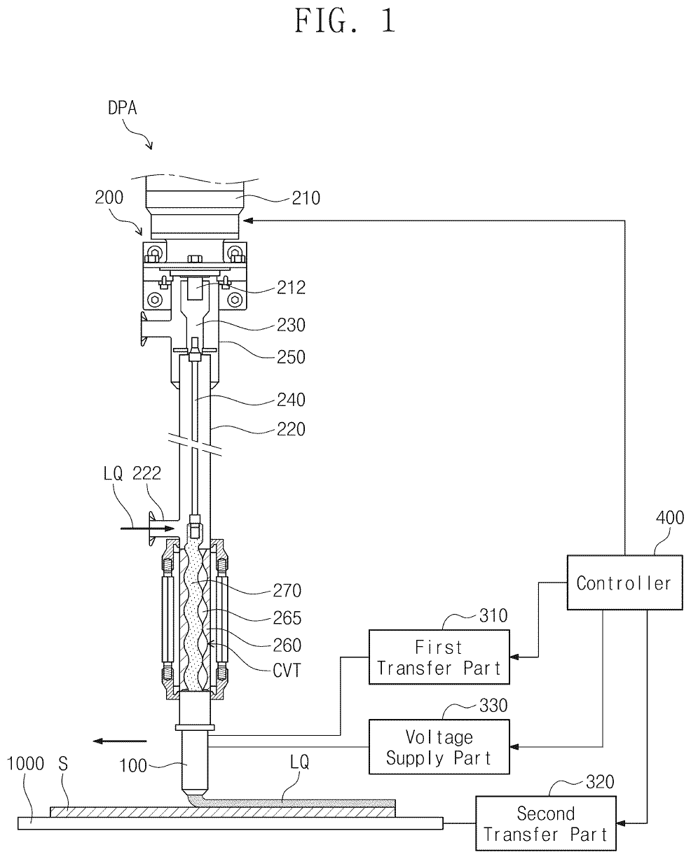

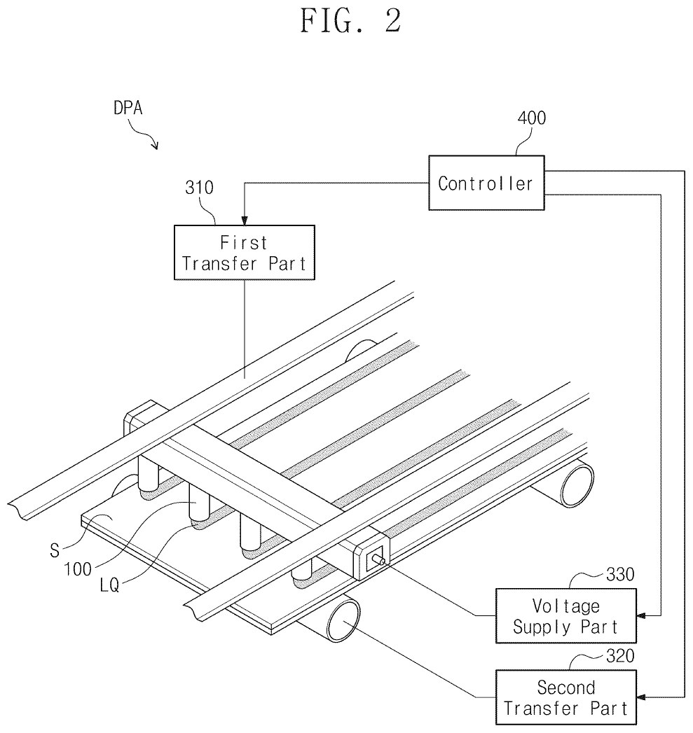

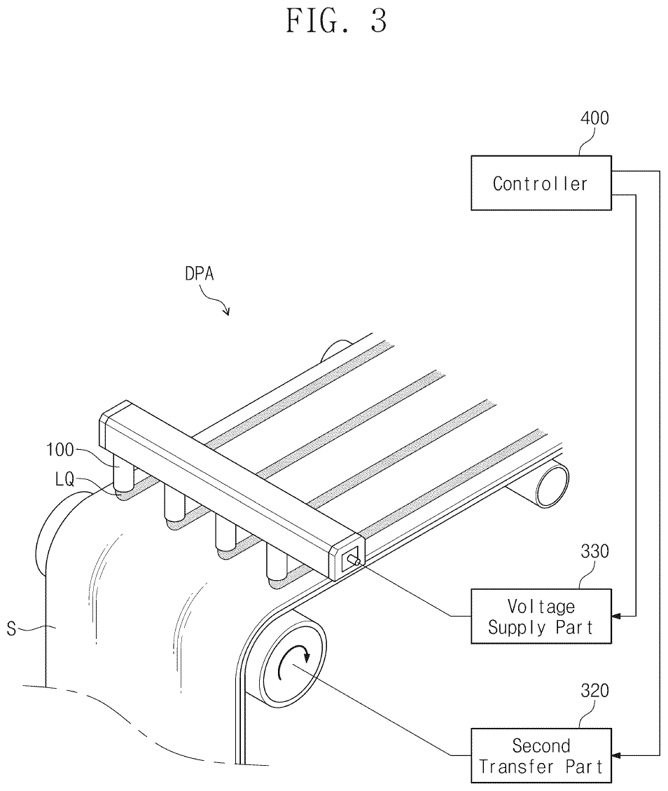

FIG. 1 is a schematic view illustrating a configuration of a contact-type patterning apparatus according to some embodiments of the present disclosure. FIG. 2 is a view illustrating a contact-type patterning apparatus in a conveyor manner according to some embodiments of the present disclosure. FIG. 3 is a view illustrating a contact-type patterning apparatus in a roll-to-roll manner according to some embodiments of the present disclosure.

Referring to FIG. 1, the contact-type patterning apparatus DPA according to some embodiments of the present disclosure may include a nozzle 100, a voltage supply part (or a voltage supply, or a power supply) 330, a pump 200, transfer parts 310 and 320, and a controller 400.

The contact-type patterning apparatus DPA according to some embodiments of the present disclosure may maintain a fluid LQ ejected from the nozzle 100 to be in contact with a substrate S so as to perform a patterning process in a continuous line shape.

The nozzle 100 may be located below the pump 200. A stage 1000 may be located below the nozzle 100. The substrate S that is a workpiece may be located on the stage 1000. The substrate S may be located below the nozzle 100.

The nozzle 100 may eject the fluid LQ dispensed from the pump 200 toward the substrate S. A meniscus M of the fluid LQ may be formed in an outlet in an end of the nozzle 100.

According to the meniscus M formed in the end of the nozzle 100, the fluid LQ may be substantially in contact with the end of the nozzle 100 and the substrate S together. When the nozzle 100 or the substrate S is transferred, the patterning process in a continuous line shape may be performed while the fluid LQ is maintained to be in contact with the substrate S.

An electrode may be provided inside the nozzle 100 according to some embodiments of the present disclosure. The electrode may be provided inside the nozzle 100 separately from the nozzle 100. However, embodiments according to the present disclosure are not limited thereto, and the nozzle 100 itself may be made of a metallic material to provide the electrode.

When a high voltage is applied to the electrode from the voltage supply part 330, an electric field may be generated toward the substrate S. For example, the stage 1000 may be grounded, and a high voltage may be applied from the voltage supply part to the electrode in the nozzle 100 or the high voltage may be applied to the metallic nozzle 100, so that the electric field is generated toward the substrate S. As the voltage increases, strength of the electrical field may become greater.

Due to force of the electric field generated through the voltage applied to the electrode from the voltage supply part 330, the fluid LQ supplied into the nozzle 100 from the pump 200 may be in contact with the substrate S in a state in which the meniscus M is formed in the end of the nozzle 100.

Here, the contact between the meniscus M of the fluid LQ and the substrate S may be defined as a state in which, after the meniscus M is formed in the end of the nozzle 100, the meniscus M of the fluid LQ is in contact with the substrate S by transferring the nozzle 100 in a direction that is close to the substrate S. However, embodiments according to the present disclosure are not limited thereto, and the contact between the meniscus M of the fluid LQ and the substrate S may be defined as a state in which, after the nozzle 100 and the substrate S are transferred to be close to each other, the meniscus M of the fluid LQ is formed in the end of the nozzle 100 and simultaneously the meniscus M of the fluid LQ is in contact with the substrate S.

A spaced distance between the nozzle 100 and the substrate S may be at least 50 μm (or about 50 μm) or less, but may be changed according to a diameter of the nozzle 100, viscosity and surface tension of the fluid LQ, and the like. The fluid LQ may be in contact with the substrate S by bring the nozzle 100 close to the substrate S to be at least 50 μm (or about 50 μm) or less. However, the spaced distance between the nozzle 100 and the substrate S is not necessarily limited thereto.

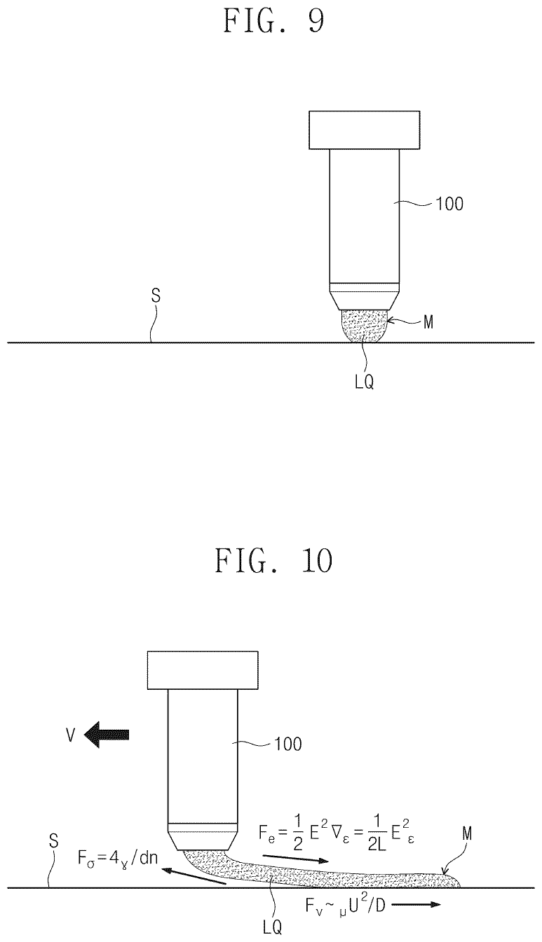

When the nozzle 100 or the substrate S is transferred due to an operation of a first transfer part 310 or a second transfer part 320 to be described later, the meniscus M may be changed into an elongated shape (illustrated in FIG. 10) due to frictional force caused by a viscosity between the substrate S and the fluid LQ so that the meniscus M is maintained in the state of being in contact with the substrate S.

As illustrated in FIGS. 2 and 3, the contact-type patterning apparatus according to some embodiments of the present disclosure may arranged a plurality of nozzles 100 to be spaced apart from each other in a line so as to pattern a plurality of line patterns at the same time.

The voltage supply part 330 applies a high voltage to the electrode of the nozzle 100. And then, according to the electric field generated due to the voltage applied to the nozzle 100 to face the substrate S, the meniscus M may be formed in the end of the nozzle 100, and also the voltage applied to the nozzle 100 may be transmitted to a surface of the fluid LQ. Even though the substrate S or the nozzle 100 moves to change the shape of the meniscus M, when the voltage is transmitted to the surface of the fluid LQ, electric stress that allows the fluid LQ to connect the substrate S and the nozzle 100 to each other may be generated. A state in which the fluid LQ connects the substrate S and the nozzle 100 to each other may be defined as a state in which the fluid LQ is in contact with the substrate S and the nozzle 100 together.

The state in which the fluid LQ is connected between the substrate S and the nozzle 100 may be provided by the surface tension generated on the surface of the fluid LQ and the frictional force between the substrate S and the fluid LQ due to the viscosity. In addition, the electric stress due to the voltage applied from the voltage supply part 330 may allow the state, in which the fluid LQ is connected between the substrate S and the nozzle 100, to be maintained during the patterning process.

The pump 200 may supply, into the nozzle 100, the fluid LQ for use in the patterning process. Here, some embodiments according to the present disclosure may use a screw-type pump that supplies the fluid LQ into the nozzle 100 through a screw rotating in response to power of the motor 210. When the screw-type pump 200 is used, the fluid LQ having a high viscosity may also be quantitatively easily supplied to the nozzle 100. According to some embodiments of the present disclosure, the fluid LQ having a viscosity of 200,000 cP (or about 200,000 cP) or less may be used to perform the patterning process.

Hereinafter, a uniaxial eccentric screw pump 200 that is one example of the screw-type pump 200 illustrated in FIG. 1 will be described.

The pump 200 may include a motor 210, a pump casing 220, a power transmitting coupling 230, a coupling rod 240, a coupling cover 250, a stator 260, and a rotor 270.

The motor 210 that operates the pump 200 may be located on the pump casing 220. An upper portion of the power transmitting coupling 230 may be connected to a shaft 212 of the motor 210, and a lower portion of the power transmitting coupling 230 may be connected to an upper end of the coupling rod 240. According to the connecting structure, the power transmitting coupling 230 may transmit the power (or torque) of the motor 210 to the coupling rod 240.

The coupling cover 250 may be connected to an upper portion of the pump casing 220. The power transmitting coupling 230 may be located inside the coupling cover 250. Here, a coupling portion between the coupling cover 250 and the motor 210 and a coupling portion between the coupling cover 250 and the pump casing 220 may be sealed. The sealing structure may block the fluid LQ supplied into the pump casing 220 from being introduced into the motor 210 located thereabove.

The coupling rod 240 may be located inside the pump casing 220. The stator 260 may be located below the pump casing 220. The rotor 270 that is coupled to a lower end of the coupling rod 240 to rotate together with the coupling rod 240 may be inserted into a cavity CVT defined inside the stator 260. The cavity CVT defined in the stator 260 may be provided to pass through the stator 260 vertically. An inner circumferential surface of the stator 260 that defines the cavity CVT may have a single-stage or multistage female screw shape.

The rotor 270 may have a single-stage or multistage male screw shape corresponding to the shape of the inner circumferential surface of the stator 260. An outer circumferential surface of the rotor 270 may have a single-stage or multistage male screw shape. When the rotor 270 is located in the cavity CVT of the stator 260, a transfer space 265 which is defined in a longitudinal direction (e.g., a vertical direction or an extension direction of the contact-type patterning apparatus DPA) may be defined. The transfer space 265 may be defined between the inner circumferential surface of the stator 260 and the outer circumferential surface of the rotor 270.

The power of the motor 210 may be transmitted to the rotor 270 through the coupling rod 240. The rotor 270 may rotate due to the power of the motor 210. Here, when the rotor 270 receives the power of the motor 210 to rotate, the rotor 270 may eccentrically rotate in the cavity CVT of the stator 260.

An inflow pipe 222 may be connected to a lower portion of the pump casing 220. The inflow pipe 222 may be connected to a tank, which stores the fluid LQ, to receive the fluid LQ.

The rotating rotor 270 may transfer the fluid LQ, which is supplied into the pump casing 220 through the inflow pipe 222 to be located in the transfer space 265, downward, i.e., in the longitudinal direction, so that the fluid LQ is quantitatively supplied into the nozzle 100.

According to some embodiments of the present disclosure, a connecting portion between the motor 210 and the rotor 270 may be made of an insulation material so that when the voltage supply part 330 supplies a high voltage to the electrode (or metallic nozzle) in the nozzle 100, the voltage is blocked from being applied to the motor 210 through the fluid LQ. Thus, the high voltage applied to the electrode in the nozzle 100 may not be delivered to the motor 210, and thus the motor 210 may not be damaged or abnormally operated.

According to some embodiments of the present disclosure, each of the coupling cover 250 and the coupling rod 240 may be made of an insulation material. The coupling cover 250 and the coupling rod 240, each of which is made of an insulation material, may block the voltage supplied to the electrode of the nozzle 100 from being transmitted to the motor 210.

The transfer parts 310 and 320 may transfer the nozzle 100 or the substrate S so that the fluid LQ is patterned in a line shape. In addition, the transfer parts 310 and 320 may transfer the nozzle 100 so as to adjust a spaced distance between the nozzle 100 and the substrate S.

The transfer parts 310 and 320 may include a first transfer part 310 and a second transfer part 320. The first transfer part 310 may transfer the nozzle 100. The first transfer part 310 illustrated in FIG. 1 may transfer the nozzle 100 in a direction (Z-axis direction) that is away from, or close to, the substrate S. However, embodiments according to the present disclosure are not limited thereto. For example, as illustrated in FIG. 2, the first transfer part 310 may transfer the nozzle 100 in a virtual plane direction (e.g., Z-axis or Y-axis direction) parallel to the substrate S. Components of the first transfer part 310 will not be described in detail as being known techniques in the printing apparatus.

The second transfer part 320 may be located below the substrate S to move the substrate S along a virtual plane parallel to the substrate S. When movement on the virtual plane parallel to the substrate S is defined as an X-axis or Y-axis movement, the second transfer part 320 may move the substrate S in a direction of at least one of the X axis or the Y axis. As illustrated in FIG. 1, when the contact-type patterning apparatus DPA according to some embodiments of the present disclosure is a stage 1000 moving-type apparatus that seats the substrate S on the stage 1000 and performs the patterning while moving the stage 1000, the second transfer part 320 may be embodied in a shape that moves the stage 1000 in the X-axis or Y-axis direction.

As illustrated in FIG. 2, when the contact-type patterning apparatus DPA according to some embodiments of the present disclosure performs the patterning while transferring the substrate S in a conveyor manner, the second transfer part 320 may be embodied in a shape that moves a conveyor (with no reference numeral), which supports the substrate S, in one direction.

Alternatively, as illustrated in FIG. 3, when the contact-type patterning apparatus DPA according to some embodiments of the present disclosure performs the patterning while transferring the substrate S in a roll-to-roll manner, the second transfer part 320 may be embodied in a manner that rotates a roller (with no reference numeral), which winds and supports the substrate S, in one direction.

The controller 400 may control an operation of each of the voltage supply part 330, the first and second transfer parts 310 and 320, and the pump 200.

The controller 400 may control a level of a voltage applied to the electrode of the nozzle 100 from the voltage supply part 330 so that the fluid LQ ejected from the end of the nozzle 100 is patterned on the substrate S in a continuous line shape. In order to maintain the state in which the fluid LQ dispensed from the end of the nozzle 100 is in contact with the substrate S, the level of the voltage applied to the nozzle 100 from the voltage supply part 330 has a great impact, and thus it is important that the level of the voltage is controlled as appropriate through the controller 400.

The controller 400 may adjust the level of the voltage applied to the electrode of the nozzle 100 from the voltage supply part 330 to perform control so that the meniscus M is formed at a side of the outlet in the end of the nozzle 100. In addition, when the nozzle 100 and the substrate S are moved relative to each other by the first and second transfer parts 310 and 320, the controller 400 may perform control so that the meniscus M is not disconnected between the substrate S and the nozzle 100.

A force applied to the fluid LQ when the substrate S or the nozzle 100 move may be frictional force caused by viscosity, surface tension, and electric stress caused by a voltage applied to a surface of the fluid LQ. Due to an interaction among the frictional force, the surface tension, and the electric stress, the state in which the fluid LQ is connected between the substrate S and the nozzle 100 may be maintained so that the process for patterning a continuous line is performed.

For example, when the fluid LQ having a high viscosity is used for the patterning process like embodiments of the present disclosure, it is very difficult to form the meniscus M in the end of the nozzle 100 due to the viscosity and the surface tension. Thus, it is important to apply an appropriate voltage to the nozzle 100 from the voltage supply part 330 to form the meniscus M.

In addition, the controller 400 may control movement of a motor of a driving part constituting the first transfer part 310 or the second transfer part 320. For example, when the first transfer part 310 is embodied to move the nozzle 100 in a direction of at least one of the X, Y, or Z axis, the controller 400 may control an operation (particularly, speed) of the motor that drives the nozzle 100 in a direction of a specific axis.

In addition, when the second transfer part 320 is embodied to move the stage 1000 as illustrated in FIG. 1, the controller 400 may control an operation (particularly, speed) of the motor that moves the stage 1000.

When the second transfer part 320 is embodied to drive the conveyor as illustrated in FIG. 2, the controller 400 may control an operation (particularly, speed) of the motor that operates the conveyor.

When the second transfer part 320 is embodied to drive a roller that winds and supports the substrate S as illustrated in FIG. 3, the controller 400 may control an operation (particularly, speed) of the motor that rotates the roller.

Thus, the controller 400 may control an operation of the first transfer part 310 or the second transfer part 320 to control a transfer speed of the nozzle 100 or the substrate S so that a patterning rate is controlled.

As described above, the patterning rate, the viscosity of the fluid LQ, and the level of the voltage applied to the surface of the fluid LQ need to be adjusted in order to define a continuous line pattern. An operation of the first transfer part 310 or the second transfer part 320 may be controlled by the controller 400 to control the transfer speed of the nozzle 100 or the substrate S so that the patterning rate is controlled.

The level of the voltage applied from the voltage supply part 330 may be changed depending on a relative velocity between the substrate S and the nozzle 100.

According to some embodiments, the contact-type patterning apparatus DPA may further include a flow rate monitoring part that monitors a flow rate of the fluid LQ ejected from the nozzle 100. The flow rate monitoring part may include a camera that photographs the fluid LQ ejected from the nozzle 100, but is not necessarily limited thereto.

A state of the patterning may be monitored in real time by the flow rate monitoring part. For example, when occurrence of disconnection of the pattern or a change in size of the pattern is confirmed through the flow rate monitoring part, the controller 400 may control the patterning rate or control the level of the voltage applied from the voltage supply part 330 so that a uniform and continuous patterning process is performed.

Hereinafter, a control operation of the controller 400 according to some embodiments of the present disclosure will be described below in more detail.

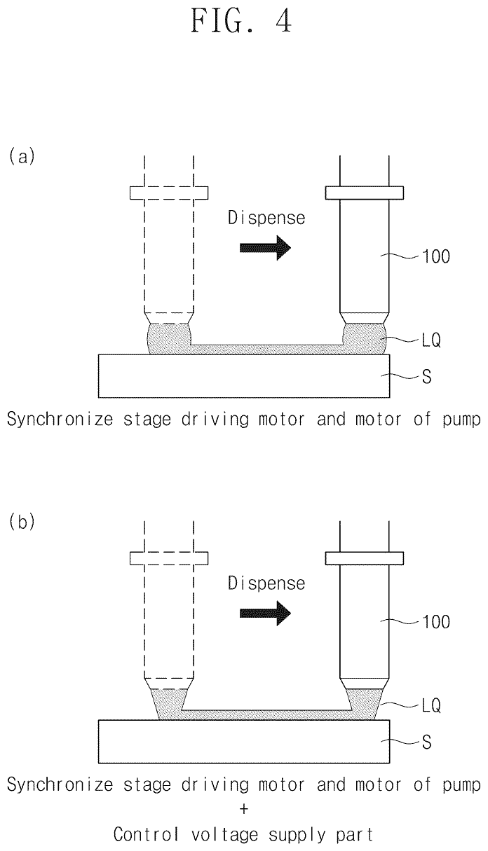

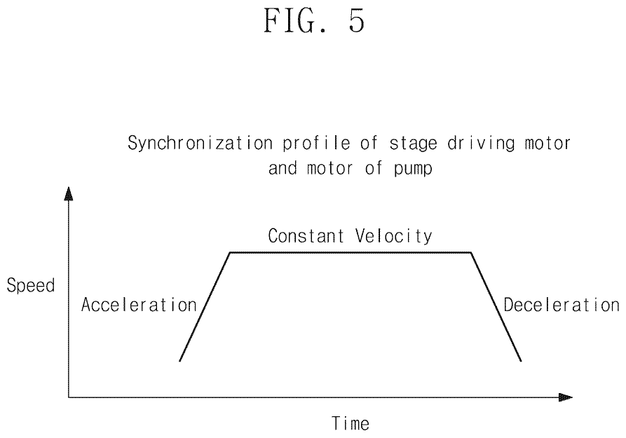

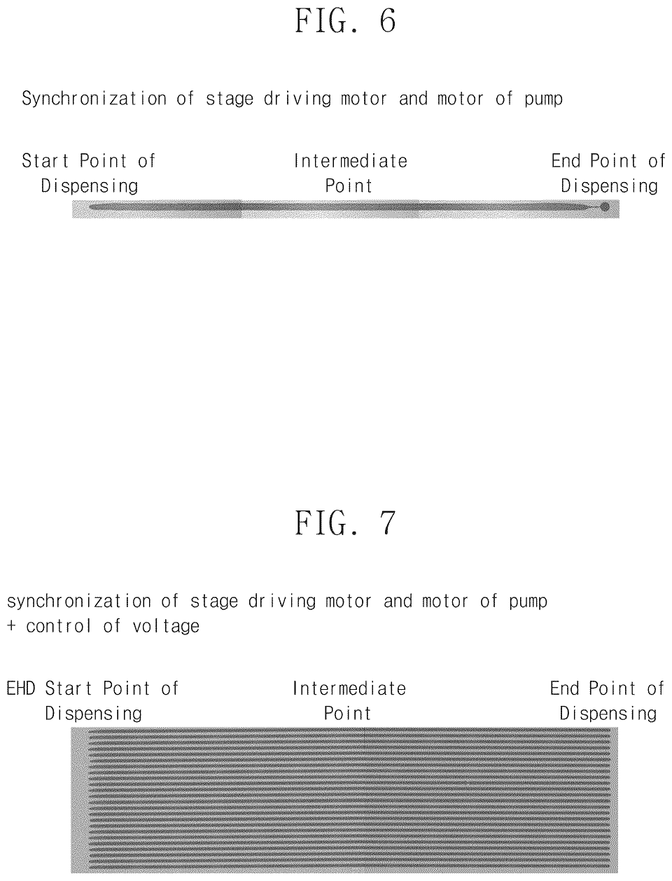

FIG. 4 is a view for comparing ejected shapes of inks according to control of a controller. FIG. 5 is a view illustrating one example of a synchronization profile of a stage driving motor and a motor of a pump according to a patterning section. FIG. 6 is a view illustrating a result of synchronizing a stage driving motor and a motor of a pump to perform a patterning process. FIG. 7 is a view illustrating a result of synchronizing a stage driving motor and a motor of a pump and also controlling a level of a voltage applied to an electrode from a controller to perform patterning.

Referring to FIG. 1, the controller 400 may synchronize a rotation speed of the motor 210 of the pump and a movement speed between the substrate S and the nozzle 100 by the first transfer part 210 or the second transfer part 310. Hereinafter, a case in which when the substrate S and the nozzle 320 are moved relative to each other for the continuous patterning process, a position of the nozzle 100 is fixed, and the stage 1000 is driven by the second transfer part 320 to move the substrate S, will be described as an example.

The second transfer part 320 may include a stage driving motor (with no reference numeral) for driving the stage 1000. According to some embodiments of the present disclosure, the controller 400 may control a rotation speed of the motor 210 and a stage driving motor of the second transfer part 320 that drives the stage 1000, and may synchronize and control the rotation speed of the motor 210 and the stage driving motor.

Referring to FIG. 5, in an acceleration section when the patterning starts, the controller 400 may perform control so that when the rotation speed of the stage driving motor is increased to an acceleration (e.g., a set or predetermined acceleration), the rotation speed of the motor 210 is also increased to the acceleration (e.g., a set or predetermined acceleration). When the patterning is performed at a constant velocity in a patterning midsection, the controller 400 may perform control so that the rotation speed of the stage driving motor and the rotation speed of the motor 210 are constant. In addition, in a deceleration section adjacent to a point at which the patterning ends, the controller 400 may perform control so that when the rotation speed of the stage driving motor is decreased to an acceleration (e.g., a set or predetermined acceleration), the rotation speed of the motor 210 is also decreased to the acceleration (e.g., a set or predetermined acceleration).

Accordingly, when the patterning rate is increased, the controller 400 may increase the flow rate of the fluid LQ introduced into the nozzle 100 from the pump 200 in proportion to the patterning rate, and when the patterning rate is decreased, the controller 400 may decrease the flow rate of the fluid LQ introduced into the nozzle 100 from the pump 200 in proportion to the patterning rate.

Here, according to some embodiments of the present disclosure, the controller 400 may control the level of the voltage applied from the voltage supply part 330 differently according to the synchronized patterning rate so as to perform control so that a line width or thickness to be patterned is constant.

For example, as illustrated in FIG. 5, in the acceleration section in which the continuous patterning starts, and the deceleration section in which the continuous patterning ends, the controller 400 may supply a voltage having an appropriate level to the electrode of the nozzle 100 according to synchronized velocity distribution so that patterning having a constant line width or thickness is defined also around a start point and an end point.

Referring to (a) of FIG. 4, when only synchronization is performed on the motor of the stage driving motor and the motor 210, a lump phenomenon of a chemical liquid (fluid LQ described above) ejected from the nozzle 100 may occur according to the meniscus M of the chemical liquid. For example, a section in which the patterning rate is low is prone to the lump phenomenon.

Referring to (b) of FIG. 4, when operations of the motor of the stage driving motor and the motor 210 are synchronized and also the level of the voltage applied to the electrode from the voltage supply part 330 is controlled, the lump phenomenon may be controlled.

Referring to FIG. 6, FIG. 6 illustrates a result when only the synchronization of the stage driving motor and the motor 210 is performed to perform the patterning process. It may be confirmed that the lump phenomenon occurs in the acceleration and deceleration sections for the start point and the end point so that the patterning is formed in line widths/thicknesses different from those of an intermediate point.

Referring to FIG. 7, it may be confirmed that when the patterning is performed by controlling the level of the voltage applied to the electrode of the nozzle 100 from the voltage supply part 330 together with the synchronization of the stage driving motor and the motor 210, the patterning is formed in a constant line width/thickness over the entirety section including the start point and the end point.

Hereinafter, a contact-type patterning apparatus according to some embodiments of the present disclosure will be described in more detail.

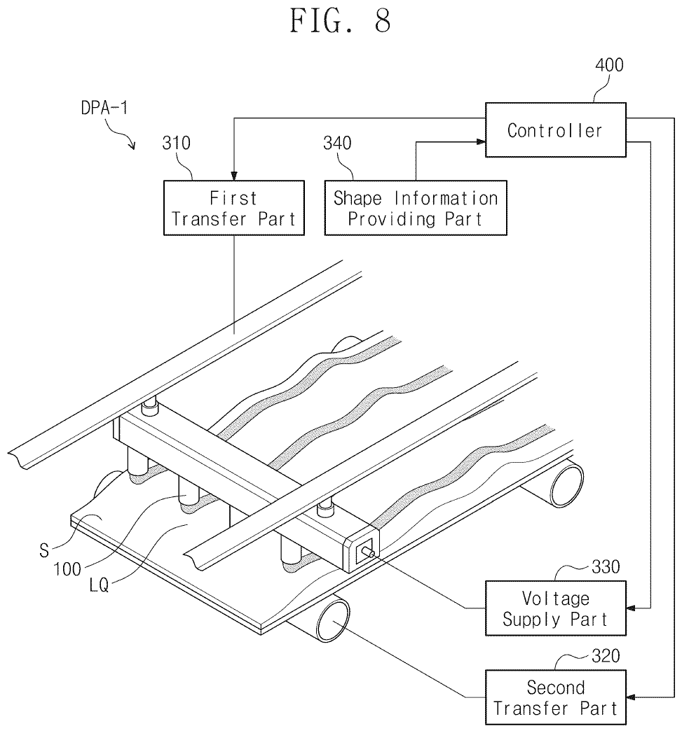

FIG. 8 illustrates a contact-type patterning apparatus for a substrate S having a three-dimensional surface according to some embodiments of the present disclosure.

FIG. 8 relates to a contact-type patterning apparatus DPA-1 capable of patterning a continuous line shape on a substrate S having a three-dimensional shape, of which a surface is not planar, while maintaining a state in which a fluid LQ dispensed through a nozzle 100 is in contact with the substrate S. Hereinafter, the contact-type patterning apparatus DPA-1 illustrated in FIG. 8 will be described by focusing on differences with the contact-type patterning apparatus DPA described with reference to FIGS. 1 to 7.

Referring to FIG. 8, the contact-type patterning apparatus DPA-1 may further include a shape information providing part 340 together with the nozzle 100, the voltage supply part 330, the pump 200, the first and second transfer parts 310 and 320, and the controller 400 that are described above. The shape information providing part 340 may obtain and store shape information of a surface of the substrate S, and provide the controller 400 with the shape information of the surface of the substrate S.

According to some embodiments of the present disclosure, the shape information providing part 340 may provide the controller 400 with the shape information of the substrate S in such a manner that the information of the surface of the substrate S is measured and stored in real time simultaneously (or concurrently) with the patterning process. However, embodiments according to the present disclosure are not limited thereto, and the shape information of the surface of the substrate S may be obtained and stored before the patterning process so that the shape information is provided to the controller 400.

Vision sensors such as displacement sensor, touch sensor, capacitance sensor, infrared ray sensor, and interferometer, may be utilized for sensing the information on the surface of the substrate (S), but embodiments according to the present disclosure are not limited thereto. For example, all of existing sensors capable of measuring a three-dimensional surface may be utilized.

The controller 400 may control a level of a voltage applied to an electrode in the nozzle 100 from the voltage supply part 330 so that the fluid LQ ejected from an end of the nozzle 100 is patterned on the substrate S in a continuous line shape.

The controller 400 may receive shape information of a surface of the substrate S from the shape information providing part 340 to control the level of the voltage applied to the electrode in the nozzle 100 from the voltage supply part 330. In addition, the controller 400 may receive information of the surface of the substrate S from the shape information providing part 340 to control the first and second transfer parts 310 and 320, thereby controlling a patterning rate according to the shape information. In addition, the controller 400 may receive height information of the shape information of the surface of the substrate S to adjust a spaced distance between the nozzle 100 and the substrate S, thereby maintaining a state in which the meniscus M and the substrate S are in contact with each other.

Distribution of an electric field may be changed because of the influence of a shape of a structure around an area to be patterned from the nozzle 100 or a previously patterned pattern. For example, when the nozzle 100 is moved with respect to the three-dimensional surface, the distribution of the electric field may be changed in real time according to a change in shape of the three-dimensional surface. According to some embodiments of the present disclosure, a change in three-dimensional electric field distribution due to the shape of the structure around the area to be patterned or the previously patterned pattern may be obtained through a simulation using a computer. Based on this change, the controller 400 may control the level of the voltage applied to the electrode of the nozzle 100 through the voltage supply part 330.

Hereinafter, an operation of a contact-type patterning apparatus according to some embodiments of the present disclosure will be described below in more detail.

FIGS. 9 and 10 are views for describing a patterning operation of a contact-type patterning apparatus according to some embodiments of the present disclosure.

Referring to FIG. 9, when a voltage is applied to an electrode of a nozzle 100 through a voltage supply part 330, an electric field may be generated toward a substrate S, and the voltage may be applied to a surface of a fluid LQ so that a meniscus M having a convex shape is formed in an end of the nozzle 100.

Here, in consideration of a viscosity of the fluid LQ, the controller 400 may adopt an appropriate level of the voltage applied from the voltage supply part 330 to perform control so that the meniscus M having a convex shape is formed in the end of the nozzle 100.

When a size of the meniscus M formed in the end of the nozzle 100 is considered, a spaced distance between the substrate S and the nozzle 100 may be set to at least ½ or less of the size of the meniscus M formed at a side of the nozzle 100. When the spaced distance between the substrate S and the nozzle 100 is set to be greater than the aforesaid, the fluid LQ may be disconnected. When the nozzle 100 having a size of 100 μm (or about 100 μm) or less used generally for micro-patterning is adopted, the spaced distance between the substrate S and the nozzle 100 may be set to 50 μm (or about 50 μm) or less.

When the meniscus M is formed, in a state in which the substrate S and the nozzle 100 are arranged to be close to each other by a first transfer part 310, the meniscus M may be formed, and the meniscus M of the fluid LQ may be in contact with the substrate S at the same time. However, embodiments according to the present disclosure are not limited thereto. For example, the meniscus M may be formed in the end of the nozzle 100, and then the nozzle 100 may be moved to a side of the substrate S by the first transfer part 310 so that the meniscus M of the fluid LQ is in contact with the substrate S.

Referring FIG. 10, in a state in which the meniscus M is in contact with the substrate S, the controller 400 may operate the first transfer part 310 or the second transfer part 320, and the nozzle 100 or the substrate S may be transferred by the first and second transfer parts 310 and 320 to perform a line patterning process.

Here, in a situation in which the fluid LQ used for the patterning is preset, a viscosity of the fluid LQ corresponds to a constant number, and thus variables that maintain continuity of a line during the line patterning process may be a patterning rate and a level of the voltage applied from the voltage supply part 330. As described above, the patterning rate may be adjusted by controlling the first transfer part 310 or the second transfer part 320 by the controller 400 to control a movement speed of the nozzle 100 or the substrate S.

Here, the controller 400 may synchronize a rotation speed of a motor 210 and the movement speed between the substrate S and the nozzle 100 by the first transfer part 210 or the second transfer part 310. Accordingly, when the patterning rate is increased, a flow rate of the fluid LQ introduced into the nozzle 100 from a pump 200 may be increased in proportion to the patterning rate, and when the patterning rate is decreased, the flow rate of the fluid LQ introduced into the nozzle 100 from the pump 200 may be decreased in proportion to the patterning rate.

The controller 400 may control the level of the voltage applied to the electrode of the nozzle 100 from the voltage supply part 330 according to the synchronized speed of the motor 210 so that the fluid LQ is maintained to be in contact with the substrate S, and also disconnection of the fluid LQ between the substrate S and the nozzle 100 may be prevented or reduced. Thus, patterning in a continuous line shape may be formed. In addition, through the adjustment of the level of the voltage, a lump phenomenon may not occur, and a line width or thickness to be patterned may be controlled to be constant.

Here, a principle that instances of disconnection of the fluid LQ between the substrate S and the nozzle 100 is prevented or reduced may be explained through equilibrium of three forces that are a frictional force between the substrate S and the fluid LQ due to the viscosity, surface tension of the fluid LQ, and electric stress caused by the voltage applied to the fluid LQ.

Referring to FIG. 10, in a case in which the voltage is not applied to the nozzle 100, surface tension (Fσ) and frictional force (Fu) due to the viscosity are applied to the meniscus M, and these are each represented by the following Equation 1.

$${F}_{σ} = \frac{4 γ}{dn} \qquad Equation 1$$

$${f}_{v} = μ \frac{{U}^{2}}{D}$$

Here, γ indicates a surface tension coefficient of the fluid LQ, dn indicates a diameter of the nozzle 100, μ indicates a viscosity of the fluid LQ, U indicates a movement speed of the nozzle 100, and D indicates a spaced distance between the nozzle 100 and the substrate S.

The aforementioned surface tension (Fσ) and friction force (Fu) due to the viscosity constitute an equilibrium equation together with a hydrostatic pressure (ΔP) of the fluid LQ, and this is as in the following Equation 2.

$$Δ P - \frac{4 γ}{dn} + μ \frac{{U}^{2}}{D} = 0 \qquad Equation 2$$

Here, a balance equation for a flow rate (Q) of the fluid LQ dispensed from the nozzle 100 is as in the following Equation 3.

$$Q = \frac{π {dn}^{4}}{128 μ L} ( Δ P - \frac{4 γ}{dn} + μ \frac{{U}^{2}}{D} ) \qquad Equation 3$$

Here, L indicates a length of the nozzle 100.

That is, in a case in which a voltage is not applied to the nozzle 100, the balance equation for the flow rate (Q) may be satisfied to perform the patterning process.

Here, when a voltage is applied to the nozzle 100, electric force (Fe) is applied in addition to the surface tension (Fσ) and the frictional force (Fu) due to the viscosity, and this is as in the following Equation 4.

$${F}_{e} = \frac{1}{2} {E}^{2} ∇ ε = \frac{1}{2 L} {E}^{2} ε \qquad Equation 4$$

Here, E indicates a level of the applied voltage, and & indicates a dielectric constant of the fluid LQ.

Due to the aforementioned electric force (Fe), the equilibrium equation and the balance equation are as in the following Equation 5.

$$Δ P - \frac{4 γ}{dn} + μ \frac{{U}^{2}}{D} + \frac{{E}^{2} ε}{2} = 0 \qquad Equation 5$$

$$Q = \frac{π {dn}^{4}}{128 μ L} ( Δ P - \frac{4 γ}{dn} + μ \frac{{U}^{2}}{D} + \frac{{E}^{2} ε}{2} )$$

That is, when a contact-type patterning process is performed, an important factor involving the patterning rate is a flow rate (Q) ejected from the nozzle 100. When a voltage is not applied, the flow rate may be determined simply by the hydrostatic pressure, but when a voltage is applied, the voltage may serve to increase the flow rate (Q). Thus, even when the patterning rate is increased, as a liquid surface of the meniscus M is stretched, the patterning process may be performed so that patterning in a continuous line shape is formed.

The contact-type patterning apparatus according to some embodiments of the present disclosure may perform the patterning process for forming the line pattern even with the ink having the high viscosity in the contact manner without the discontinuous section.

In addition, the contact-type patterning apparatus according to some embodiments of the present disclosure may perform the patterning process for forming the line pattern having the constant line width even in the acceleration and deceleration sections around the start point and the end point of the pattern when compared to the intermediate point.

In addition, the contact-type patterning apparatus according to some embodiments of the present disclosure may block the voltage applied to the nozzle from being introduced into the driving part (e.g., motor) of the pump to prevent or reduce damage to the equipment or avoid or reduce the pattern precision being reduced.

Although aspects of some embodiments of the present disclosure have been described, it is understood that embodiments according to the present disclosure should not be limited to these embodiments but various changes and modifications can be made by one ordinary skilled in the art within the spirit and scope of embodiments according to the present disclosure as hereinafter claimed. In addition, the embodiments set forth herein are to describe the technical spirit of the present invention and not to limit, and these embodiments set forth herein are provided so that this disclosure will be thorough and complete, and will more fully convey the scope of embodiments according to the present disclosure to those skilled in the art.

What is claimed is:

1. A contact-type patterning apparatus comprising:
a nozzle comprising an electrode configured to receive a voltage to generate an electric field toward a substrate, and configured to eject a fluid so that the fluid is connected to the substrate;
a voltage supply configured to apply the voltage to the electrode;
a screw-type pump configured to supply the fluid into the nozzle through a screw configured to receive power from a motor to rotate;
a transfer part configured to transfer the nozzle or the substrate so that the fluid is patterned in a line shape; and
a controller configured to control a level of the voltage applied through the voltage supply, an operation of the transfer part, and an operation of the pump.

2. The contact-type patterning apparatus of claim 1, wherein the controller is configured to synchronize and to control a transfer speed of the substrate or the nozzle by the transfer part and a rotation speed of the motor of the pump, and to control the level of the voltage applied to the electrode from the voltage supply according to the synchronized speed control.

3. The contact-type patterning apparatus of claim 2, wherein, in an acceleration section of the transfer part in which the patterning starts, and a deceleration section of the transfer part in which the patterning ends,
the controller is configured to synchronize and control the transfer speed of the substrate or the nozzle by the transfer part and the rotation speed of the motor of the pump, and to control the level of the voltage applied to the electrode from the voltage supply according to the synchronized speed control.

4. The contact-type patterning apparatus of claim 3, wherein the contact-type patterning apparatus is configured to transfer the substrate in a stage moving manner, and
the controller is configured to control a movement speed of a stage, which supports the substrate, to control the transfer speed of the substrate.

5. The contact-type patterning apparatus of claim 3, wherein the contact-type patterning apparatus is configured to transfer the substrate in a roll-to-roll manner, and
the controller is configured to control a rotation speed of a roll, which supports the substrate, to control the transfer speed of the substrate.

6. The contact-type patterning apparatus of claim 3, wherein the contact-type patterning apparatus is configured to transfer the substrate in a conveyor manner, and
the controller is configured to control a movement speed of a conveyor, on which the substrate is seated, to control the transfer speed of the substrate.

7. The contact-type patterning apparatus of claim 1, wherein a connecting portion between the motor of the pump and the screw includes an insulation material such that a voltage supplied from the voltage supply is blocked from being applied to the motor.

8. The contact-type patterning apparatus of claim 1, wherein the fluid has a viscosity of 200,000 cP or less.

9. The contact-type patterning apparatus of claim 1, further comprising a shape information providing part configured to provide three-dimensional surface shape information of the substrate,
wherein, in consideration of a change in distribution of the electric field according to the three-dimensional surface shape information provided from the shape information providing part, the controller is configured to control the level of the voltage applied to the electrode through the voltage supply.

10. The contact-type patterning apparatus of claim 1, further comprising a flow rate monitoring part configured to monitor a flow rate of the fluid ejected from the nozzle.

11. The contact-type patterning apparatus of claim 10, wherein the flow rate monitoring part comprises a camera configured to photograph the fluid ejected from the nozzle.

12. The contact-type patterning apparatus of claim 1, wherein the pump is a uniaxial eccentric screw pump.
